(19) United States
(12) Patent Application Publication
(10) Pub. No.: US 2007/0241166 A1
(43) Pub. Date: Oct. 18, 2007

(54) Carbon fiber heating plate device

(76) Inventor: Steven Yue, Taipei (TW)

Correspondence Address: LADAS & PARRY, 5670 WILSHIRE BOULEVARD, SUITE 2100, LOS ANGELES, CA, 90036-5679, US

(21) Appl. No.: 11/503,563

(22) Filed: Aug. 11, 2006

(30) Foreign Application Priority Data
Apr. 14, 2006 (CN) 200610072388.1

(51) Int. Cl. A47J 36/02

(52) U.S. Cl. 228/101

(57) ABSTRACT

A carbon fiber heating plate device includes an insulating plate with two opposite edges each of which has a plurality of spaced apart turning sites, a carbon fiber wiring disposed over at least one face of the insulating plate, extending from one edge to the other edge of the insulating plate, and having a plurality of spaced apart turns arranged at the turning sites, respectively, and anti-break units each provided at one of the turning sites to prevent one of the turns of the carbon fiber wiring from contacting directly the corresponding one of the turning sites.

### BACKGROUND OF THE INVENTION

1. Field of the Invention

The invention relates to a carbon fiber heating plate device, more particularly to one having a carbon fiber wiring which is disposed on at least one face of an insulating plate and which is bent at edges of the insulating plate.

2. Description of the Related Art

Various forms of heating devices are available in the market. One form of the heating devices is a ceramic heating device, which has ceramic plates for generating heat. However, the ceramic-type heating devices are heavy and bulky. Another type of heating device utilizes a heated oil circulating within fin-like hollow heating plates that release heat to ambient air. The construction of such a heating device is complicated. Still another type of heating devices includes carbon lamps, halogen lamps and quartz lamps that produce heat by cooperating with reflecting back plates. The sizes of such heating devices are so large that there is a high incidence that the user might get burn. Yet another type of heating device employs a nichrome heating wire wound around a cylindrical body. This type of heating device is also bulky as the angle that the nichrome heating wire can be bent is limited due to poor ductility of the nichrome wire. Therefore, further improvements to develop a heating device with a reduced size are desirable.

### SUMMARY OF THE INVENTION

Therefore, an object of the present invention is to provide a carbon fiber heating plate device with a simple construction and a compact size.

Another object of the present invention is to provide a carbon fiber heating plate device with anti-break units to protect a carbon fiber wiring from breakage.

Accordingly, a carbon fiber heating plate device according to the present invention comprises: an insulating plate including two opposite faces, and two opposite edges each of which has a plurality of spaced apart turning sites; a carbon fiber wiring extending over at least one of the faces from one of the edges to the other one of the edges, and having a plurality of spaced apart turns arranged at the turning sites, respectively; and anti-break units each provided at one of the turning sites to prevent one of the turns of the carbon fiber wiring from contacting directly the corresponding one of the turning sites.

### BRIEF DESCRIPTION OF THE DRAWINGS

Other features and advantages of the present invention will become apparent in the following detailed description of the preferred embodiments with reference to the accompanying drawings, of which:

FIG. 1 is a plan view of the first preferred embodiment of a carbon fiber heating plate device according to the present invention;

FIG. 2 is a fragmentary perspective view of the first preferred embodiment;

FIG. 3 is a fragmentary plan view showing a portion of a carbon fiber wiring of the first preferred embodiment;

FIG. 4 is a fragmentary sectional view taken along line 4-4 of FIG. 2;

FIG. 5 is a plan view of the second preferred embodiment of the present invention;

FIG. 6 is a plan view of the third preferred embodiment of the present invention;

FIG. 7 is a perspective view of an anti-break unit used in the third preferred embodiment of the present invention;

FIG. 8 is a plan view of the fourth preferred embodiment of the present invention;

FIG. 9 is a plan view of the fifth preferred embodiment of the present invention;

FIG. 10 is a plan view of the sixth preferred embodiment of the present invention;

FIG. 11 is a plan view of the seventh preferred embodiment of the present invention; and

FIG. 12 is a plan view of the eighth preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

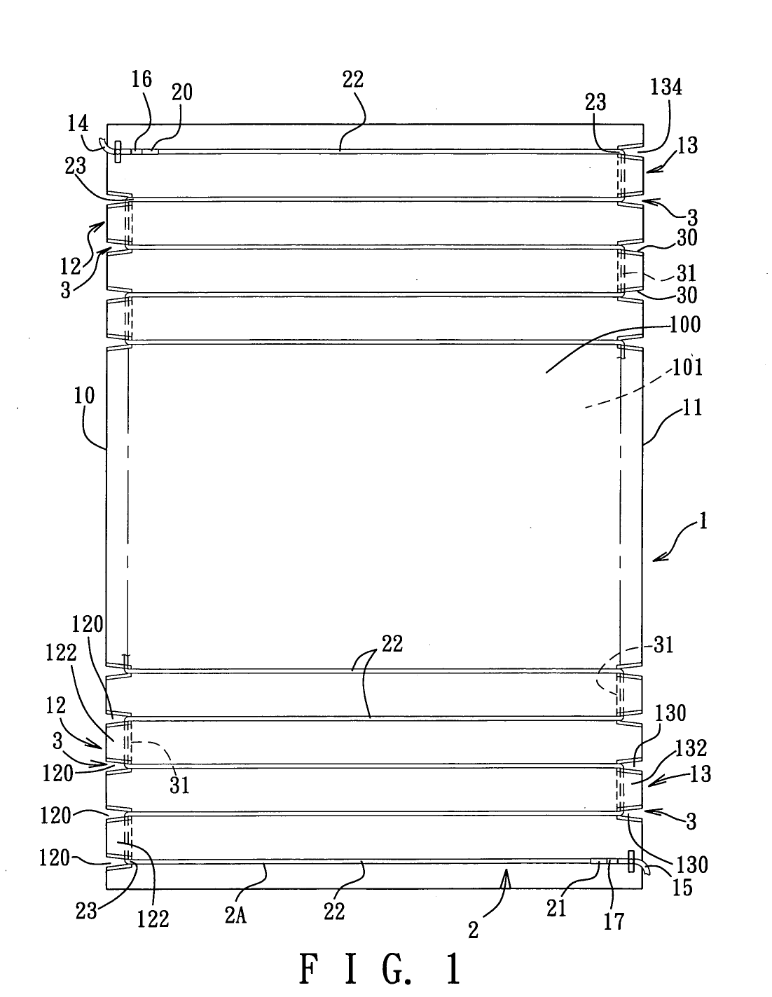

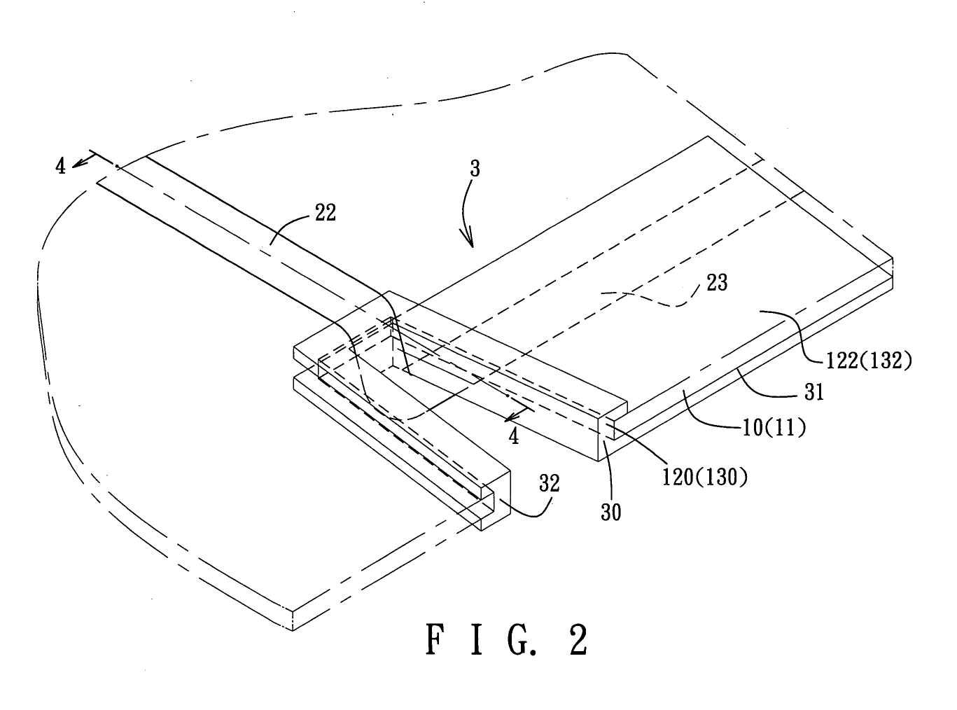

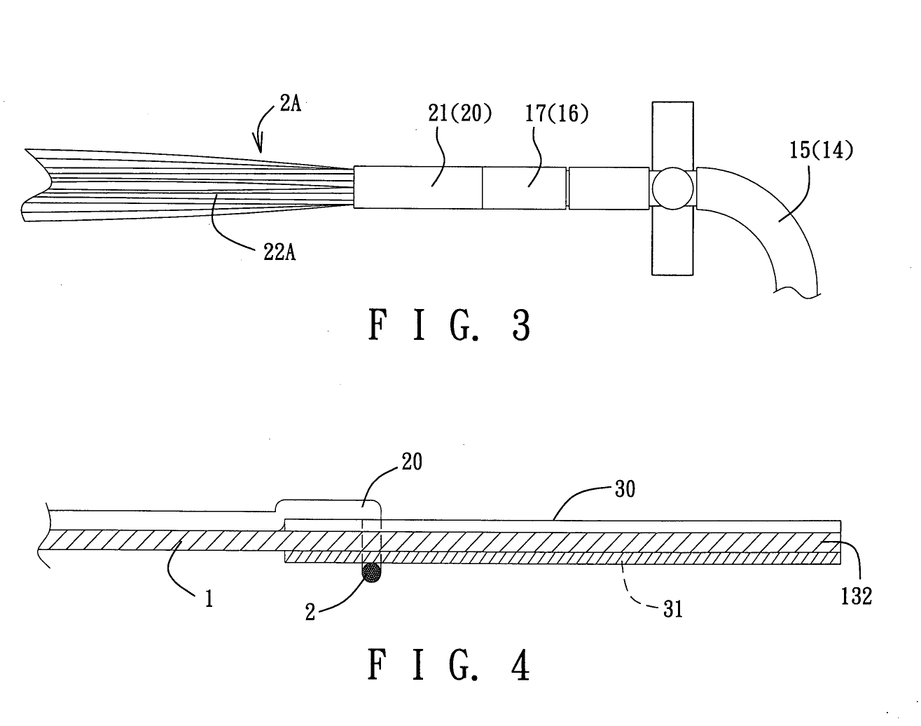

Referring to FIGS. 1 to 4, there is shown the first preferred embodiment of a carbon fiber heating plate device according to the present invention, which includes a high heat-resisting insulating plate 1 that has two opposite faces 100, 101, and two opposite edges 10, 11 each having a plurality of turning sites 12, 13 that are provided with a plurality of anti-break units 3, respectively. A carbon fiber wiring 2 is provided on one of the faces 100, 101 of the insulating plate 1 and has two ends for connection with an electric source (not shown).

The insulating plate 1 is preferably a mica plate that is highly resistant to heat. The carbon fiber wiring 2 is disposed over one of the faces 100, 101 of the insulating plate 1 and includes a single carbon fiber bundle 2A. The single carbon fiber bundle 2A is formed into a plurality of wire lines 22 that extends from the edge 10 to the edge 11, and a plurality of turns 23 formed at the turning sites 12, 13, respectively. Two ends of the carbon fiber bundle 2A are connected respectively to two conductors 14, 15 through two electric connecting members 16, 17, respectively. While the carbon fiber wiring 2 is formed from the single carbon fiber bundle 2A, it is contemplated that two or more than two carbon fiber bundles could be used to form the carbon fiber wiring 2.

Each edge 10, 11 of the insulating plate 1 is notched to form a plurality of indented edge parts 120, 130 to provide the turning sites 12, 13. Each turning site 12 thus includes two adjacent indented edge parts 120 and a flank 122 between the two adjacent indented edge parts 120. Similarly, each turning site 13 thus includes two adjacent indented edge parts 130 and a flank 132 between the two adjacent indented edge parts 130. Preferably, each indented edge part 120, 130 is substantially U-shaped.

The anti-break units 3 are provided at the respective turning sites 12, 13 to prevent the carbon fiber bundle 2A from contacting directly the sharp edges of the indented edge parts 120, 130. Each anti-break unit 3 is preferably made of a metal having high electrical conductivity. In this embodiment, a thin copper plate is used to make the anti-break units 3.

As best shown in FIGS. 1, 2 and 4, each anti-break unit 3 includes two opposite edge-covering members 30 and a flank-covering member 31 connected between the edge-covering members 30. Each edge-covering member 30 is a channel member 32 that substantially corresponds in shape to the corresponding indented edge part 120, 130 and that receives and clamps the corresponding indented edge part 120, 130. The flank-covering member 31 is a flat plate part that is connected between the two channel members 32 of the opposite edge-covering members 30 and that extends over the corresponding flank 122, 132.

Each turn 23 of the carbon fiber bundle 2A is a U turn formed at one of the turning sites 12, 13 and connects with two adjacent ones of the wire lines 22. In particular, each turn 23 is bent substantially by 90° at two adjacent indented edge parts 120, 130 and extends across the corresponding flank 122, 132. The carbon fiber bundle 2A is turned alternately at the edges 10, 11 of the insulating plate 1 to form the wire lines 22.

Referring once again to FIGS. 1 & 3, the carbon fiber bundle 2A have two conductive sleeves 20, 21 fitting around two ends of the carbon fiber bundle 2A, respectively, and connected to the respective electric connecting members 16, 17. A naked carbon fiber section 22A between the conductive sleeves 20, 21 has a plurality of naked carbon fibers.

The anti-break units 3 serve to protect the carbon fiber bundle 2A from breaking due to the turning of the carbon fiber bundle 2A at the sharp edges 10, 11 of the insulating plate 1. As the indented edge parts 120, 130 are covered by the anti-break units 3, the carbon fiber bundle 2A is prevented from contacting directly the indented edge parts 120, 130. In addition, when an electric current is applied to the carbon fiber bundle 2A to produce heat, the temperature of the carbon fiber bundle 2A at the turns 23 can be higher than that of the remaining parts of the carbon fiber bundle 2A. Due to the presence of the anti-break units 3 according to the present invention, the high temperature heat produced in the turns 23 can be minimized. This is because, when the electric current flows to the turns 23 of the carbon fiber bundle 2A, the electric current will flow through the anti-break units 3 rather than the turns 23 since the electrical conductivity of the anti-break units 3 is higher than that of the turns 23. As such, the temperature of the carbon fiber bundle 2A at the turns 23 may be lowered, and an incidence that the carbon fiber bundle 2A will burn due to high temperature may be reduced.

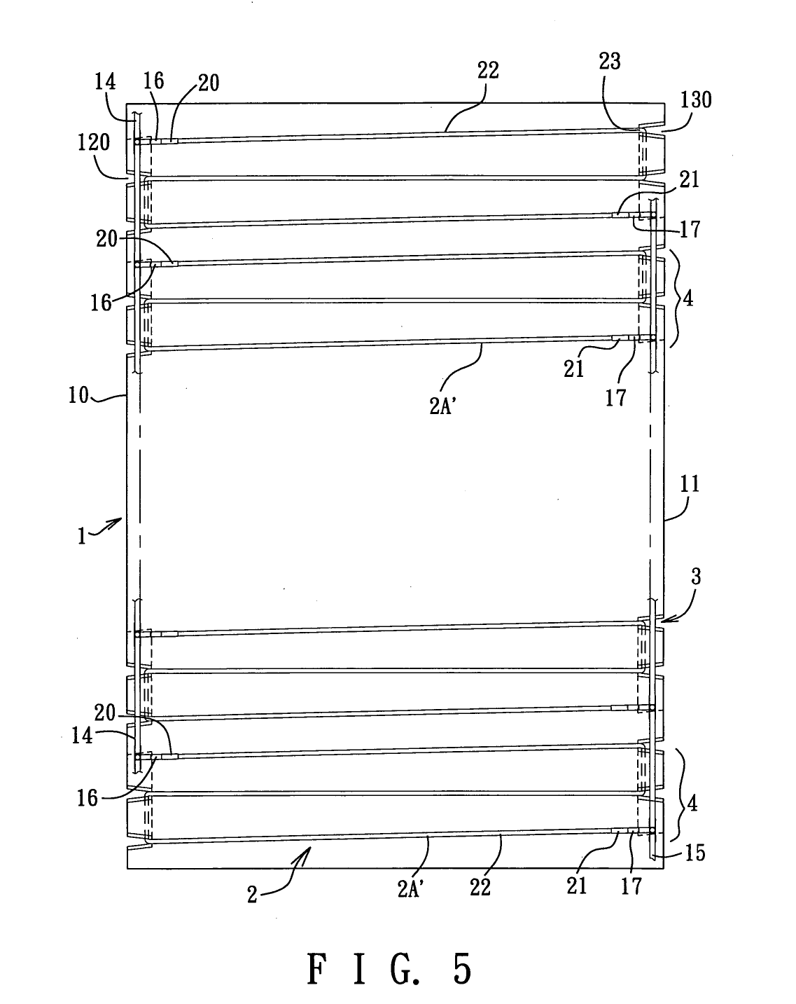

Referring to FIG. 5, there is shown the second preferred embodiment of the present invention which differs from the first preferred embodiment in that the carbon fiber wiring 2 is formed by using a plurality of carbon fiber bundles 2A′. Each carbon fiber bundle 2A′ is disposed in one of a plurality of regions 4 on the insulating plate 1 and is formed into at least three wire lines 22. A pair of conductors 14, 15 are provided to extend along and proximate to the two edges 10, 11 of the insulating plate 1, respectively. Each carbon fiber bundle 2A′ has two conductive sleeves 20, 21 connected respectively to the conductors 14, 15 through the respective electric connecting members 16, 17. Preferably, the electric connecting members 16, 17 are riveted to the respective anti-break units 3 and the insulating plate 1 by using rivets (not shown) that extend through the respective flank-covering members 31 of the anti-break units 3. The electric connecting members 16, 17 and the anti-break units 3 are therefore secured to the insulating plate 1. The two conductive sleeves 20, 21 of each carbon fiber bundle 2A′ are connected electrically and respectively to the electric connecting members 16, 17. As such, the carbon fiber bundles 2A′ are interconnected electrically in parallel. With the carbon fiber wiring 2 of this embodiment, the making of a long heating plate device is possible. In case a single carbon fiber bundle is used in making a long heating plate device, the carbon fiber bundle must be very long. As the power output of the carbon fiber bundle is likely to decrease as the length of the carbon fiber bundle increases, a very long carbon fiber bundle cannot provide a uniform heating. Since the carbon fiber bundles 2A′ used in this embodiment are relatively short and operate independently, uniform heating can be achieved.

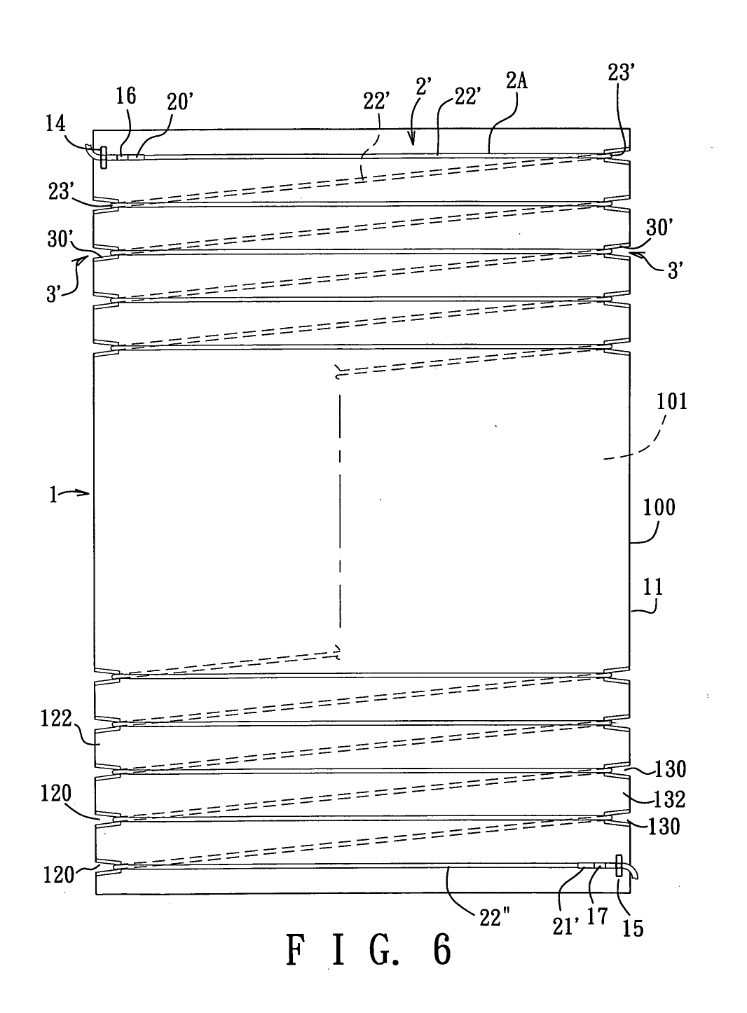

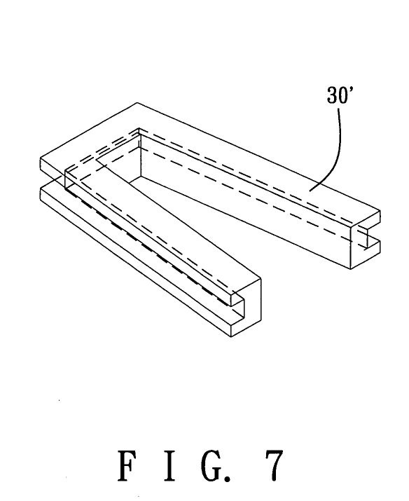

Referring to FIGS. 6 and 7, there is shown a third preferred embodiment of the present invention which differs from the first embodiment in that a carbon fiber wiring 2′ is provided to extend over two opposite faces 100, 101 of the insulating plate 1, that each indented edge parts 120, 130 serves as a turning site, and that each anti-break unit 3′ has a single edge-covering member 30′ covering one of the indented edge parts 120, 130. The single edge-covering member 30′ is formed as a channel member. The carbon fiber wiring 2′ includes a single carbon fiber bundle 2A that is wound around the insulating plate 1 by turning the single carbon fiber bundle 2A about the indented edge parts 120, 130. In particular, the single carbon fiber bundle 2A is bent at each indented edge part 120, 130 to extend from one of the faces 100, 101 to the other one of the faces 100, 101, thereby forming a plurality of spaced apart wire lines 22′ on the two faces 100, 101 and a plurality of turns 23′ at the indented edge parts 120, 130, respectively.

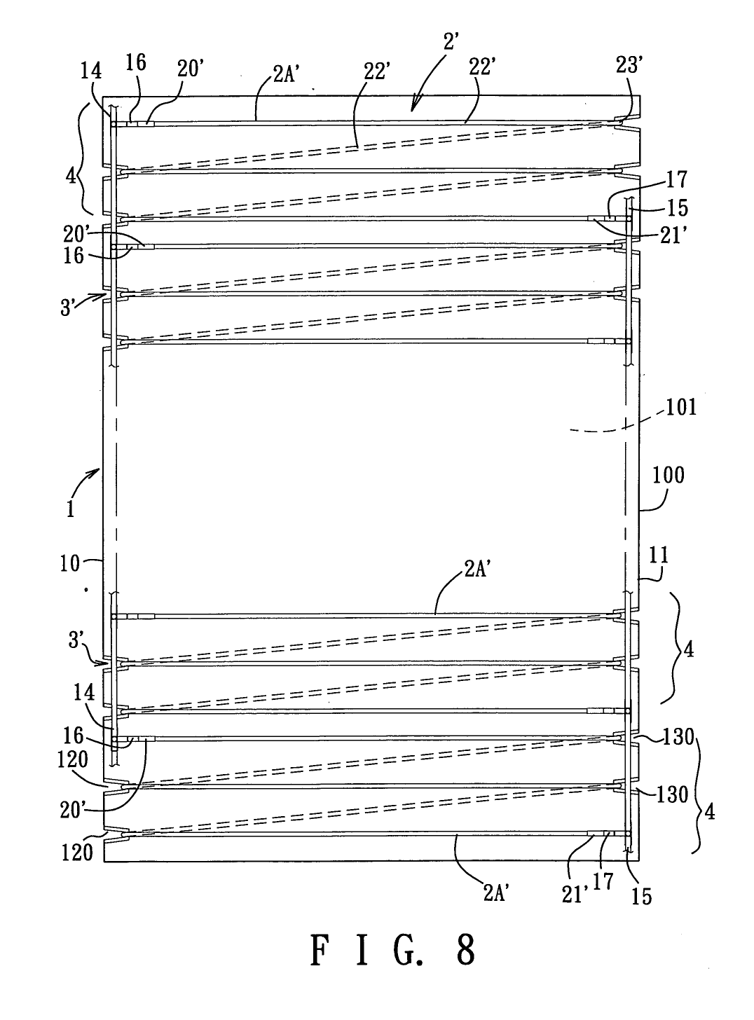

Referring to FIG. 8, there is shown a fourth preferred embodiment of the present invention which differs from the third preferred embodiment in that a carbon fiber wiring 2′ disposed on two faces 100, 101 of the insulating plate 1 is formed from a plurality of carbon fiber bundles 2A′ each of which is wound around the insulating plate 1 in one of the regions 4 of the insulating plate 1 to form at least three wire lines 22′ and which are interconnected electrically through a parallel connection. Each carbon fiber bundle 2A′ has two conductive sleeves 20′, 21′ connected electrically to conductors 14, 15 through conductive connecting members 16, 17, respectively.

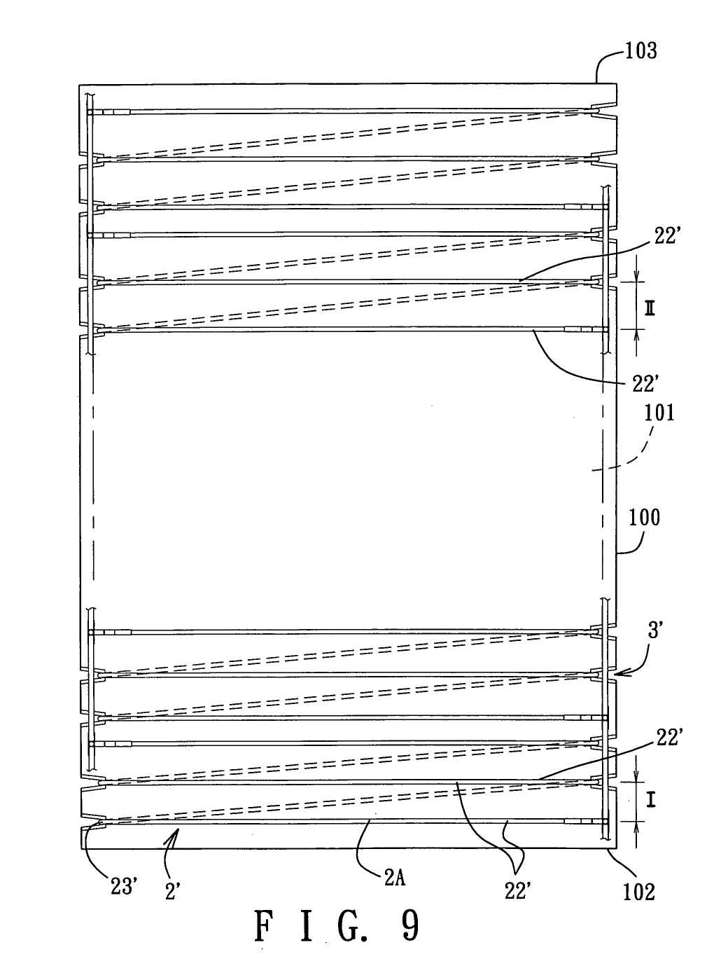

Referring to FIG. 9, there is shown a fifth preferred embodiment of the present invention which differs from the third preferred embodiment in that the insulating plate 1 is a vertical type insulating plate that has a bottom side 102 and a top side 103 and that the spacing between the wire lines 22′ decreases from the bottom side 102 to the top side 103. In other words, the spacing (I) proximate to the bottom side 102 is smaller than the spacing (II) proximate to the top side 103. As the wire lines 22′ are distributed more densely at the lower part of the insulating plate 1 compared to the upper part thereof, the heating temperature provided by the carbon fiber bundle 2A is higher at the lower part. The air heated by the high temperature heat at the lower part of the insulating plate 1 can flow upward to serve as a natural heating medium to heat the upper part of the insulating plate 1.

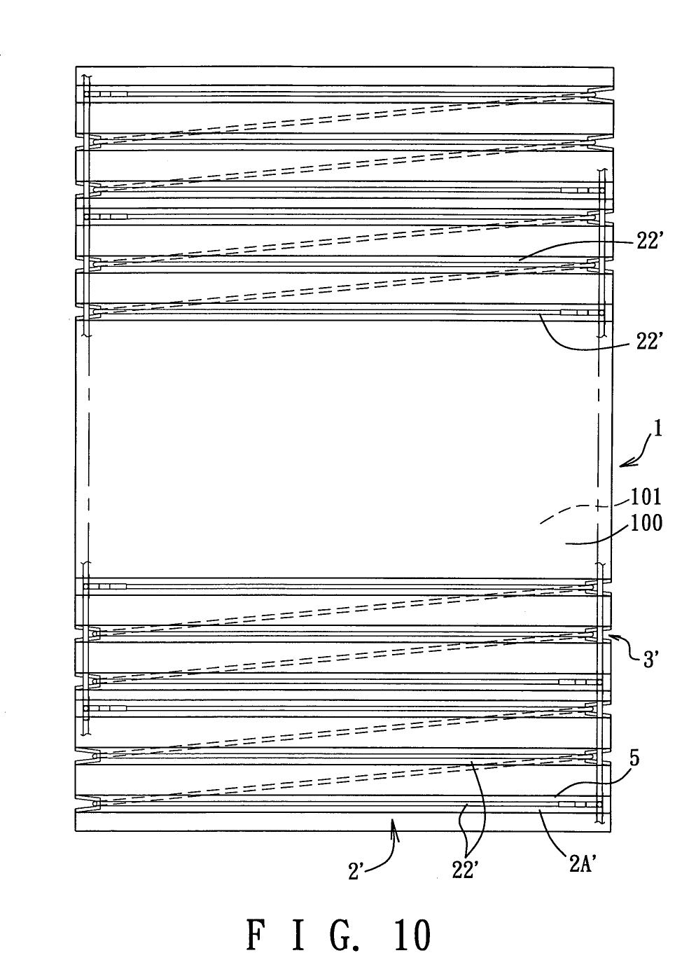

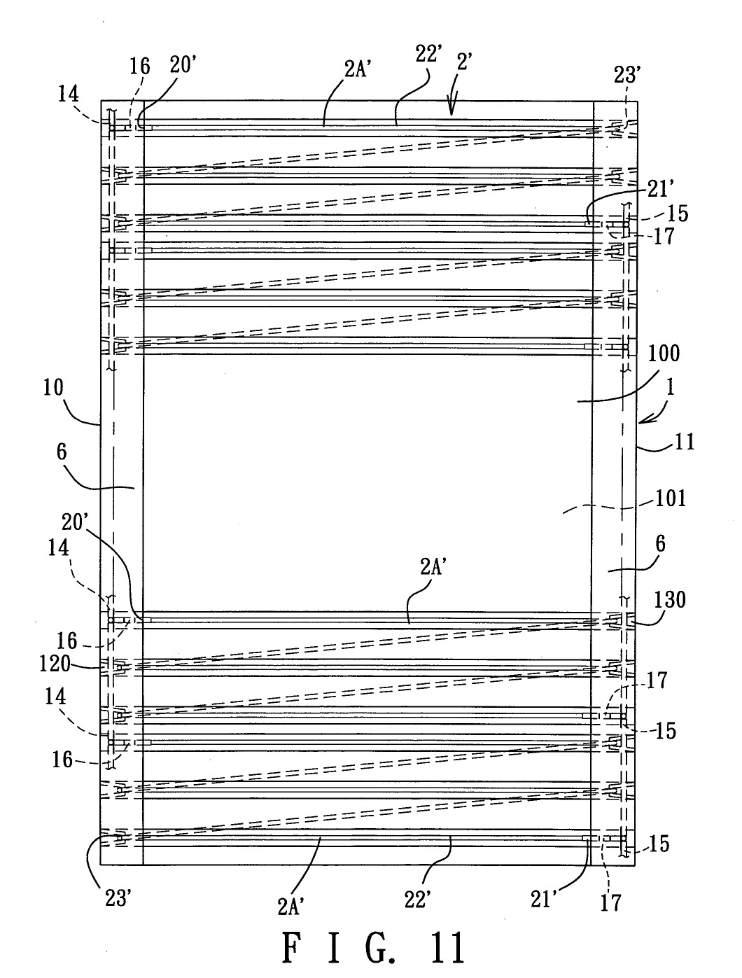

Referring to FIG. 10, there is shown the sixth preferred embodiment of the present invention which differs from the fourth preferred embodiment in that the wire lines 22′ are fixed to the face 100 of the insulating plate 1 using a plurality of thermally conductive adhesive tapes 5 that extend over the wire lines 22′, respectively, so that the wire lines 22′ are prevented from becoming loosened when the insulating plate 1 is placed vertically.

Referring to FIG. 11, there is shown the seventh preferred embodiment of the present invention which differs from the fourth preferred embodiment in that two heat-resistant insulative protection strips 6 are adhered to the face 100 of the insulating plate 1 along the two edges 10, 11 to cover and protect the turns 23′ and the conductive sleeves 20′, 21′ of the carbon fiber bundles 2A′, the conductors 14, 15, and the electric connecting members 16, 17. Alternatively, the protection strips 6 may be adhered to both of the faces 100, 101 of the insulating plate 1.

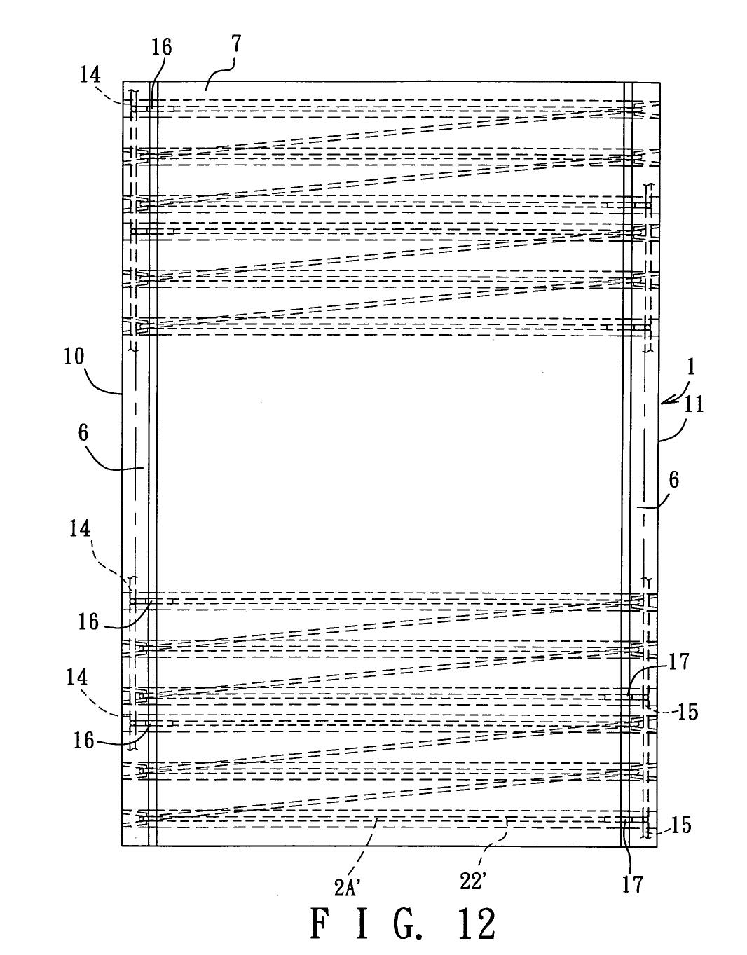

Referring to FIG. 12, there is shown the eighth preferred embodiment of the present invention which differs from the seventh preferred embodiment in that an additional heat-resistant insulative cover plate 7 is disposed over one or two of the faces 100, 101 between the protection strips 6 so as to cover and protect the wire lines 22′ of the carbon fiber bundles 2A′. Preferably, the cover plate 7 is formed of mica strips or plates which have good heat-absorbing and heat-dissipating characteristics.

As described hereinbefore, the anti-break units 3, 3′ are made of a high heat-resisting metal, such as, copper. However, it is contemplated that the anti-break units 3, 3′ could be made of a heat-resisting plastic plate or tape to cover the indented edge parts 120, 130 and the flanks 122, 132 of the insulating plate 1.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A carbon fiber heating plate device comprising:
an insulating plate including two opposite faces, and two opposite edges each of which has a plurality of spaced apart turning sites;
a carbon fiber wiring extending over at least one of said faces from one of said edges to the other one of said edges, and having a plurality of spaced apart turns arranged at said turning sites, respectively; and
anti-break units each provided at one of said turning sites to prevent one of said turns of said carbon fiber wiring from contacting directly the corresponding one of said turning sites.

2. The carbon fiber heating plate device of claim 1, wherein said edges of said insulating plate are notched to form a plurality of spaced apart indented edge parts so as to provide said turning sites.

3. The carbon fiber heating plate device of claim 2, wherein said insulating plate is a mica plate.

4. The carbon fiber heating plate device of claim 2, wherein each of said anti-break units has an edge-covering member to cover at least one of said indented edge parts.

5. The carbon fiber heating plate device of claim 4, wherein said edge-covering member is formed as a channel member to receive and clamp one of said indented edge parts.

6. The carbon fiber heating plate device of claim 5, wherein said edge-covering member is made of a thin metal plate that is bent to form said channel member.

7. The carbon fiber heating plate device of claim 5, wherein each of said turning sites includes one of said indented edge parts, each of said indented edge parts being substantially U-shaped, said channel member substantially corresponding in shape to a corresponding one of said indented edge parts.

8. The carbon fiber heating plate device of claim 2, wherein each of said turning sites includes two adjacent ones of said indented edge parts, and a flank formed between said adjacent ones of said indented edge parts.

9. The carbon fiber heating plate device of claim 8, wherein each of said turns of said carbon fiber wiring is a U turn that turns at said adjacent ones of said indented edge parts and that extends across said flank, said carbon fiber wiring further including a plurality of spaced apart wire lines that extend over said one of said faces of said insulating plate, said U turn of each of said turns being connected to a pair of said wire lines.

10. The carbon fiber heating plate device of claim 9, wherein each of said anti-break units includes two opposite edge-covering members respectively covering said adjacent ones of said indented edge parts, and a flank-covering member connected between said edge-covering members and covering said flank.

11. The carbon fiber heating plate device of claim 10, wherein each of said edge-covering members is formed as a channel member to receive and clamp one of said indented edge parts, said flank-covering member having a flat plate part that interconnects said channel members of said adjacent ones of said edge-covering members and that extends between said flank and a corresponding one of said turns of said carbon fiber wiring.

12. The carbon fiber heating plate device of claim 11, wherein said anti-break units are made of a metal having a high electric conductivity.

13. The carbon fiber heating plate device of claim 4, wherein said carbon fiber wiring extends over both of said opposite faces of said insulating plate, each of said turning sites having one of said indented edge parts, said carbon fiber wiring having at least one carbon fiber bundle that is wound around said insulating plate by extending said carbon fiber bundle from one of said faces to the other one of said faces and by bending said carbon fiber bundle about said indented edge parts.

14. The carbon fiber heating plate device of claim 4, further comprising at least two conductors, and at least two electric connecting members connected respectively to said conductors proximate to said edges of said insulating plate, said carbon fiber wiring including at least one carbon fiber bundle that has two conductive sleeves respectively fitting around two ends of said carbon fiber bundle, and a naked carbon fiber section between said conductive sleeves, said conductive sleeves being connected respectively to said electric connecting members.

15. The carbon fiber heating plate device of claim 14, wherein the distance between adjacent ones of said wire lines decreases from one side to the other side of said insulating plate.

16. The carbon fiber heating plate device of claim 14, further comprising a plurality of tapes attached to said insulating plate to cover said wire lines, respectively.

17. The carbon fiber heating plate device of claim 16, further comprising two elongated heat-resistant insulative protection strips disposed along said two edges of said insulating plate to cover said indented edge parts and said turns of said carbon fiber wiring.

18. The carbon fiber heating plate device of claim 17, further comprising a heat-resistant insulative cover plate covering at least one of said faces of said insulating plate between said elongated heat-resistant insulative protection strips to cover said wire lines.
